(19) United States
(12) Patent Application Publication
(10) Pub. No.: US 2023/0380625 A1
(43) Pub. Date: Nov. 30, 2023

(54) Rotating Cooking Surface

(71) Applicant: William Shultz, North Highlands, CA (US)

(72) Inventor: William Shultz, North Highlands, CA (US)

(21) Appl. No.: 17/824,886

(22) Filed: May 25, 2022

(51) Int. Cl. A47J 37/04; A47J 36/32; A47J 37/07

(52) U.S. Cl. CPC A47J 37/043; A47J 36/32; A47J 37/0786; F24B 1/003

(57) ABSTRACT

Revisions submitted contained no new material except additional technical details of the original concept. The drawings submitted provide expanded top and side views. The descriptions for each drawing are included on the next page after the drawing. The object is round and the same from all sides. There are enough drawings to show the location of the on/off switch, location of the motor, location of the vertical axle and the relative position of all the other parts. Food grade metal is used in all parts of construction. The motor is strong enough to rotate with food on top of the cooking surface.

### SUMMARY

The benefit of a Rotating Cooking Surface is to provide even heat to a cooking surface and provide automation to the cooking process. With less monitoring of the food there are less injuries and better food quality. Every instance of tending to food on a grill is an additional opportunity for injury. Less food is wasted as a result of improving the quality of the cooking process. Health of those who use this product would be improved by preventing undercooked food. The even heat is caused by the rotating the cooking surface. The cooking surface is rotated by a vertical axle which attaches to the center of the cooking surface. The axle goes down through the heat source and through the container to a motor which provides the rotation. The motor is electrical powered. The product could vary in size however the rotating cooking surface is constant.

The existing product has a half inch castle top connected to the axle which is connected to the electrical motor. The motor rotates at approximately 2.5 rotations per minute. The existing grill is approximately 1.5 feet in diameter. The motor box is approximately 6 inches square at the base of the spherical grill structure. The motor is offset from the surface of the container to prevent heat conduction. The motor will automatically reverse direction if it encounters resistance. This prevents the motor from becoming inoperable.

There are no revisions to this page other than the header.

Utilizing a vertical axis to rotate the cooking surface of a charcoal grill is the original concept of this patent application. A spherical container with a cooking surface in the middle has an electrical motor mounted to the bottom with a vertical axle which rotates the cooking surface. The cooking surface is removable and rests on the axle in the center. The accessory to any grill is a unique application of modern technology. The motor is protected from the heat source and specifically designed for this application. The metal used is food grade steel and is fitted to the grill to rotate the cooking surface at the perfect height. The attachment point of the axle to the cooking surface may be welded or threaded on. No toxic materials would be used in production of this with the intent to produce food for human consumption.

Variations of this product would be available however the rotation about a vertical axis over a heat source is what is unique and of benefit. The function of the product is to rotate the cooking surface about a vertical axis.

There are no revisions to this page other than the header.

### HISTORY

Humans have been cooking with fire prior to keeping time. There are no products that utilize technology in the manner. Modern grills have improved on the containment and the effectiveness of the cooking process. Some ovens have horizontal rotation however the heat of an oven is relatively uniform to begin with. Grills flare up and the heat source is irregular. This product evens out the heat from coals by moving the food. There is less concentration of drippings and the food does not receive concentrated heat from the irregular heat sources. A horizontal axis rotation fails to provide the same results as this product. The food can be applied closer to the heat source and is more efficient. Food can be cooked more thoroughly and evenly. The resulting improved quality of heat improves health by raising the internal temperature more effectively. Existing grills control air flow using vents in order to control the temperature. This applies air flow control and improves on it using even heat. There is nothing in history that has applied modern technology in this manner, until now.

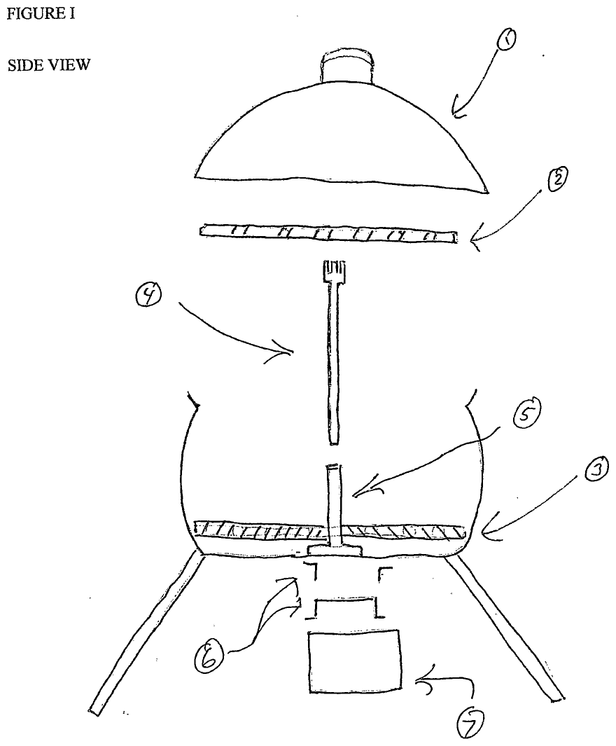

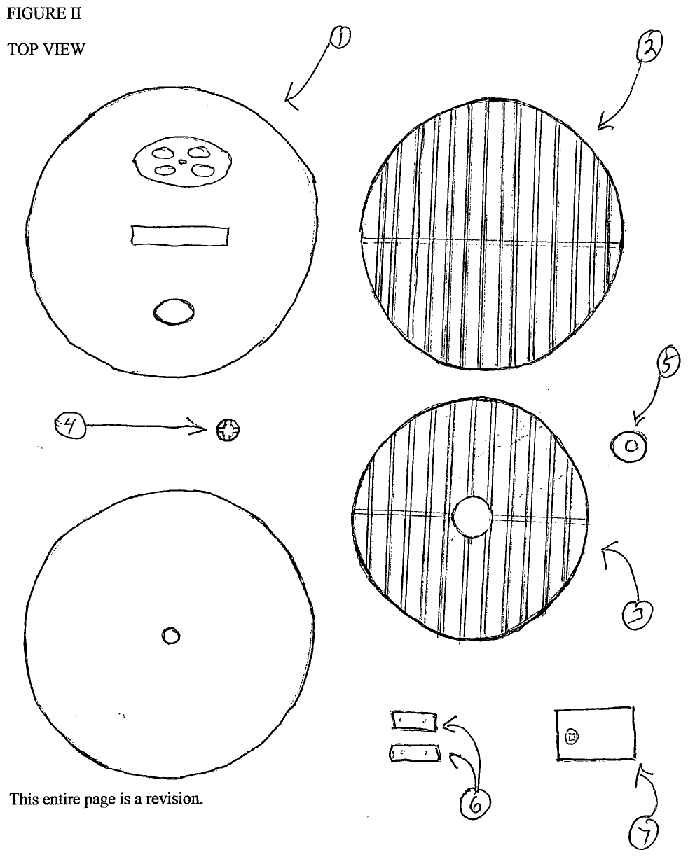

FIG. 1 Description

FIG. 1 depicts the parts prior to assembly from the side view. The first part to be installed is the heat/debris shield. Next are the motor mounting brackets. Rivets or bolts are used to hold both of the first two parts in place. The heat shield and the mounting brackets need to be attached first because they will later be inaccessible. Once the mounts are in place the motor can be attached by sliding it onto the brackets. The top of the motor has notches for the brackets to slide together. The lower grate is placed over the heat/debris shield, with has a hole in the center to accommodate the shield. The vertical axle is installed through the shield and into the motor which has a square socket which the axle fits into. The grill surface is placed onto the axle. The top of the axle is notched for the grill surface. The surface floats slightly above its original location on the frame. The frame may guide the grill surface along the circumference if necessary. Food on the cooking surface can float above the grill frame and heat source resting on the vertical axle. Once power is provided to the unit via plug or battery it is ready to start cooking. The cooking surface can be removed in order to place and ignite charcoal. There is a toggle switch on the motor to start the rotation. The lid is used to control and monitor the temperature by manipulating air ventilation. A thermometer on the lid allows the cooking process to be uninterrupted.

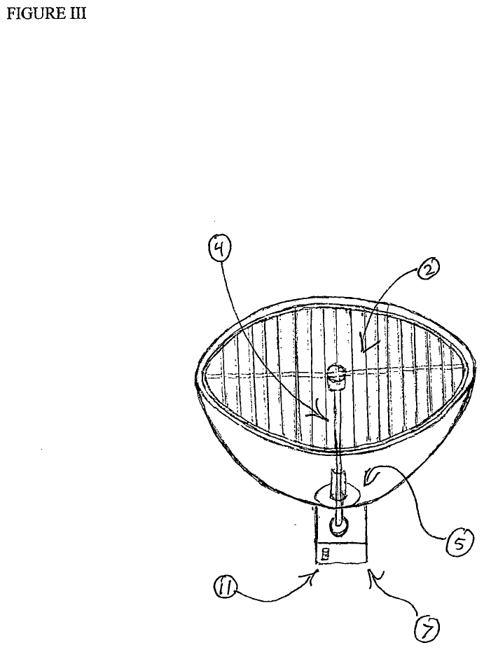

FIG. 2 Description

FIG. 2 is a depiction of the parts from above. In order from top to bottom the lid is first. The grilling surface is second. The grill surface sits on the vertical axle. The vertical axle goes through the lower charcoal grate, heat/debris shield and lower grill frame. The vertical axle fits into the square socket on the top of the motor. The motor is attached to the frame of the grill with two brackets. The brackets and the heat shield are fixed into place by rivets though the grill frame. This angle shows a center hole in the lower grate which holds the charcoal. This angle shows the top of the vertical axle which has grooves in it which keep the grill surface in place. This angle also shows the square socket of the motor into which vertical axle square end fits.

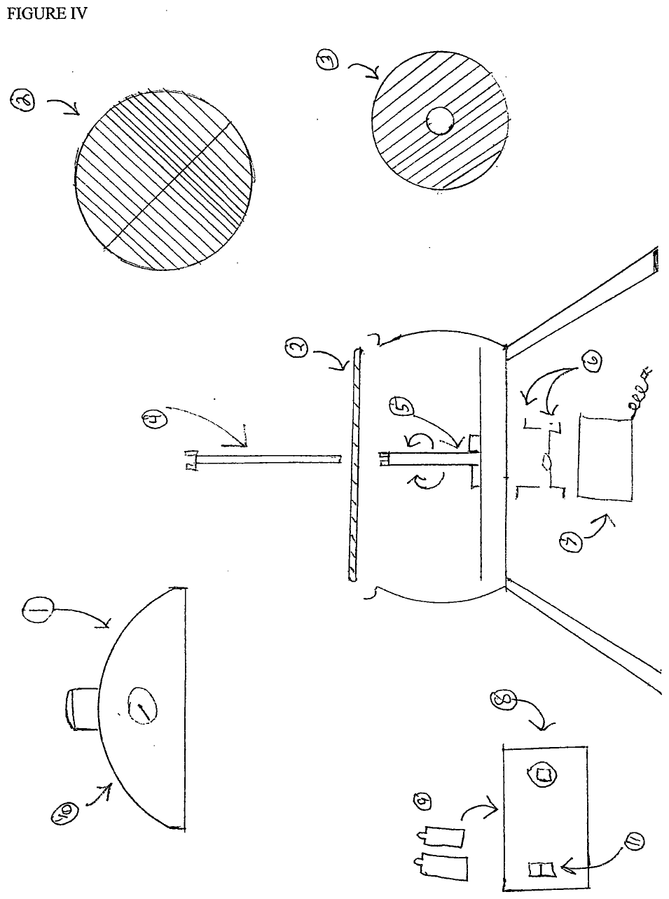

FIG. 3 Description

This drawing depicts the rotation of the cooking surface. Part of the lower grill frame is see through in order to show the internal parts. The grill is approximately at a 45 degree angle. The grill surface is shown as well as where the vertical axle attaches. The vertical axle is shown in place passing through the heat shield, lower grate and the bottom of the grill frame. The curved arrows show that the cooking surface rotates as well as the vertical axle. The motor is shown in place supporting the axle and cooking surface. The toggle switch on the motor is located on the side of the motor as pictured controls power/rotation.

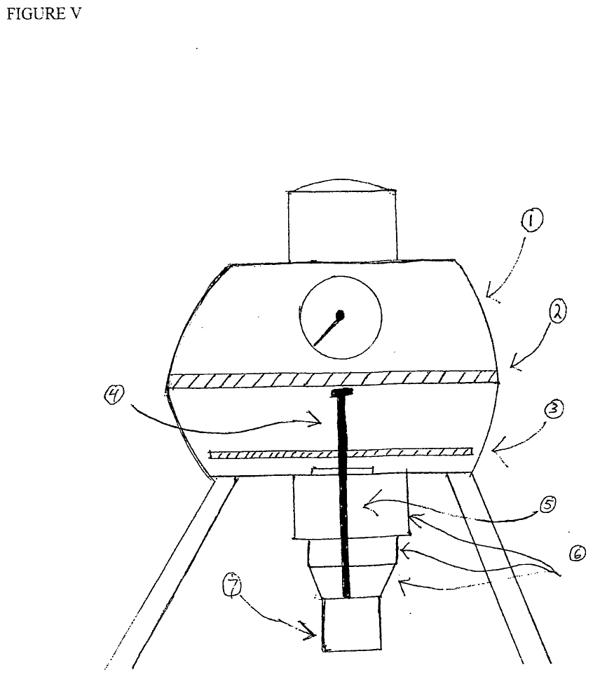

FIG. 4 Description

This drawing is a combination of top and side views. The central drawing is an expanded view of the parts. Two grates are depicted as well as a second alternative motor option. The alternate motor can be plugged in or may use batteries. The lower charcoal grate requires a hole in the center to accommodate the vertical axle and the guide/shield. This drawing indicates that the shaft can rotate either clockwise or counter-clockwise. The thermometer is shown on the lid. Two batteries can power one type of motor which is operated by a toggle switch. Two types of motors are controlled by a toggle switch.

1. The cooking surface rotates about a vertical axis. By rotating the cooking surface over the heat source the quality is improved. The temperature is more consistent and there is better control of the temperature. In combination with a thermostat the cooking process can be controlled better. The constant rotation of the cooking surface reduces burning of the food due to irregular heat. The utility of the system applies over various heat sources, sizes of cooking surface and motors/power sources. The existing product is a 14″ charcoal grill with plug or battery power. The product reduces the supervision required while improving the quality of the end result of the cooking process. The cooking surface utilizes a stem through the bottom of the grill to float the cooking surface over the heat source and rotate it. The motor is attached to the bottom of the grill frame. The motor mount supports the weight of the food being prepared and the cooking surface in addition to the motor. There is a heat and debris shield that protects the motor from charcoal ashes falling inside it. The grill person utilizes air vents to control the temperature of the coals. The grill surface rotates approximately 2.5 times per minute. Less food is wasted and food can be cooked to safe temperature with greater consistency.
